(19) United States
(12) Patent Application Publication
(10) Pub. No.: US 2012/0292346 A1
(43) Pub. Date: Nov. 22, 2012

(54) APPARATUS FOR DISPENSING A LIQUID FROM A CONTAINER

(76) Inventors: Jason K. Watson, Houston, TX (US); Heidi Hilty Rochford, Houston, TX (US)

(21) Appl. No.: 13/477,003

(22) Filed: May 21, 2012

Related U.S. Application Data
(60) Provisional application No. 61/488,025, filed on May 19, 2011.

(51) Int. Cl. B67D 7/06

(52) U.S. Cl. 222/185.1

(57) ABSTRACT

A liquid detergent dispensing aid, including a structure having four sides and a top, wherein the four sides contain a front segment and a back segment connected by two sides, and a cup holder means attached to a bottom portion of the front segment, wherein the front segment has a height shorter than the back segment, and wherein the top has a downward facing angle relative to a horizontal plane facing the front segment.

### FIELD

The present invention is generally related to liquid containers. More specifically, the present invention is related to a method and apparatus for aiding the dispensing of a liquid from a container.

### BACKGROUND

Liquid laundry detergent bottles are commonly sold in large bottles. These bottles are typically heavy and difficult to handle. These liquid detergent containers are available in volumes up to about 300 fluid ounces or more, which can be very heavy and cumbersome to lift and pour. Once purchased by the consumer, these containers are typically stored in a laundry room on a shelf or other ledge. In order to measure the proper amount of detergent needed for a load of laundry, the user must pour from a bottle that can weigh over ten pounds into a small measuring cup. This act of pouring liquid detergent into the measuring cup can be difficult, especially for those who are in a weakened condition, have a disability, or limited coordination.

A user may desire to pour the detergent into the measuring cup from a dispenser on the detergent bottle while the bottle is in a resting position (possibly on a shelf or other ledge) in order to avoid having to handle the cumbersome bottle. Dispensing the detergent in this mode creates an opportunity for spilling the liquid detergent when pouring it into the dose cup. Spilled detergent can create a mess and waste laundry detergent. For example, if the detergent bottle is placed in a shelf or other ledge above the washing machine, the act of sliding the bottle forward to expose the dispenser can create a situation where excess detergent may drip from the dispenser onto the washing machine.

It would be desirable to dispense detergent from a large liquid detergent container without having to lift and handle the container. It would also be desirable to dispense detergent from such a large liquid detergent container without dripping or spilling excess detergent.

### SUMMARY

Embodiments of the present invention generally include a liquid detergent dispensing aid apparatus including a structure having four sides and a top. The four sides contain a front segment and a back segment connected by two sides. The front segment has a height shorter than the back segment and wherein the top has a downward angle relative to a horizontal plane facing the front segment. The liquid detergent dispensing aid apparatus also includes a cup holder means attached to a bottom portion of the front segment.

The apparatus can further include a lip positioned above the front segment. The lip may be adapted to receive a dispensing nozzle of a detergent bottle.

The top includes an outer surface. At least a portion of the outer surface can include a textured surface. The textured surface may contain one or more of raised bumps, raised ridges, rubber patches, elastomeric patches, suction cups, Velcro, or adhesives.

The liquid detergent dispensing aid apparatus may have a shape that allows for multiple dispensing aids having the same size and shape to be stacked on top of each other. The shape of the liquid detergent dispensing aid allows for at least a portion of the top of a dispensing aid to fit within the bottom of another dispensing aid having the same size and shape.

Embodiments of the present invention may also include a liquid detergent dispensing system including a structure having four sides, a bottom, and a top. The four sides include a front segment and a back segment connected by two sides. The liquid detergent dispensing system also includes a liquid detergent bottle resting on the top, a cup holder attached to a bottom portion of the front segment, and a cup resting on the cup holder. The front segment has a height shorter than the back segment and the top has a downward angle relative to a horizontal plane facing the front segment. The liquid detergent bottle includes a dispensing nozzle that is positioned over the cup resting on the cup holder.

The liquid detergent dispensing system may also contain a removable support piece that includes the bottom of the structure and at least a portion of the four sides. The bottom of the structure of the liquid detergent dispensing system may contain a plurality of grooves.

### BRIEF DESCRIPTION OF DRAWINGS

FIG. 1 is a perspective view of an embodiment of a dispersing aid according to this invention.

FIG. 2 is a side view of a dispensing aid embodiment having a detergent bottle positioned on the top of the dispensing aid.

FIG. 3 is a top view of a dispensing aid embodiment.

FIG. 4 is a front facing view of an embodiment of the dispensing aid.

FIG. 5 is a cross-sectional view of an embodiment of the dispensing aid containing a bottom section.

FIG. 6 is a cross-sectional view of an embodiment of the dispensing aid not containing a solid bottom section.

FIG. 7 is an underside view of an embodiment of the dispensing aid not containing a solid bottom section.

FIG. 8 is a transparent side view showing dispensing aids in a stacked arrangement.

FIG. 9 is a cross-sectional view of an embodiment of the dispensing aid containing a bottom section having grooves.

### DETAILED DESCRIPTION

Disclosed herein is an apparatus for the dispensing of liquid detergent from a liquid detergent container. The apparatus may be a dispersing aid that includes any object that can support a liquid detergent bottle at any angle that assists the flow of detergent from the detergent bottle. In an embodiment, the dispersing aid may include any object that can support a heavy liquid detergent bottle at an angle that places the dispensing nozzle of the detergent bottle near a lowermost position in order to create a gravity flow of detergent through the dispensing nozzle.

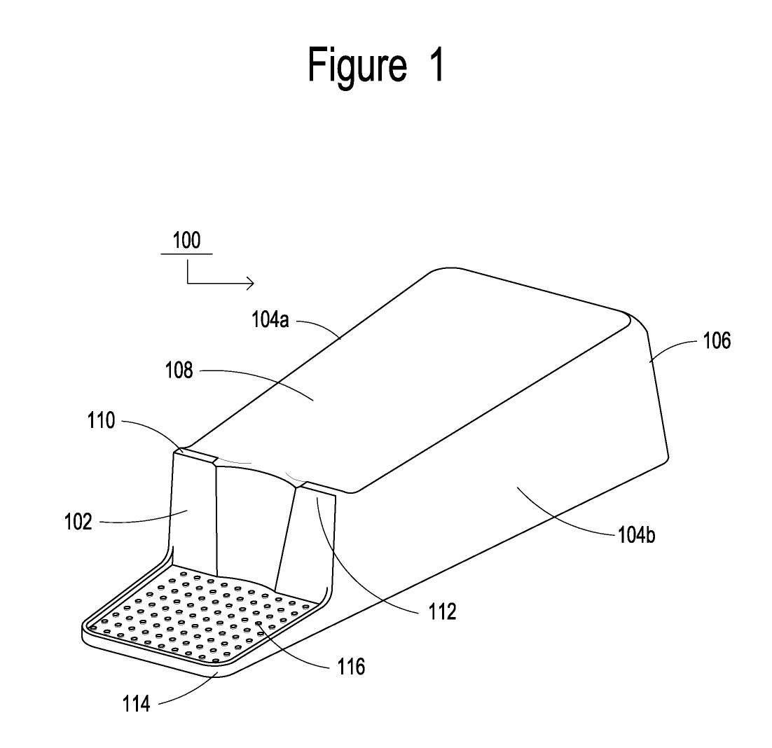

FIG. 1 depicts a perspective view of an embodiment of the dispensing aid 100 having a front 102, sides 104a (not shown) and 104b, a back 106 (not shown), and a top 108. The front 102 of the apparatus 100 may include a lip 110 attached to the top of the front surface 112 and extending upward from the top of the front surface 112. As depicted in FIG. 1, the lip 110 is flush with the outer surface of front 112. In an embodiment, the lip 110 may be offset from the outer surface of front 112 by any desired distance. The lip 110 may extend upward from the top of the front surface at any desired length. In an embodiment, the lip 110 extends upward at a length sufficient to hold, or prevent from sliding past the front surface 112, a full detergent bottle of up to 300 fluid ounces. In another embodiment, the lip 110 extends upward at a length of up to 3 inches. In an alternative embodiment, the lip 110 extends upward at a length of at least 0.1 inch. In a further embodiment, the lip 110 extends upward at a length ranging from 0.25 inch to 2 inches.

The dispensing aid 100 may further contain a cup holder 114, where a dispensing cup (not shown) may be placed. The cup holder 114 may project out from any area of the front 102. In an embodiment, the cup holder 114 may project out from any height along the bottom half of the front 102. As depicted in FIG. 1, the cup holder 114 may project out from the bottom portion of the front 102. In another embodiment, the bottom of the cup holder 114 is flush with the bottom of the remainder of the dispensing aid 100. The cup holder 114 may further contain a tray 116 placed on top of the cup holder 114 or placed within an optional recess (not shown) of the cup holder 114. The tray 116 may be removed from the cup holder 114 in order to clean the tray 116 of any excess laundry detergent or other liquid that may drip from the container (not shown). In addition to the embodiments described, the cup holder may include any means for holding a laundry detergent cup.

The top 108 of the dispensing aid 100 may be of any size or shape that is capable of holding a liquid detergent container at an angle relative to a horizontal plane. In an embodiment, the top 108 may be up to 2 feet in length and up to 8 inches in width. In another embodiment, the top 108 may range from 6 inches to 2 feet in length and from 3 inches to 8 inches in width. In a further embodiment, the top 108 may range from 9 to 15 inches in length and from 4 to 7 inches in width.

The top 108 may be positioned at any angle relative to a horizontal plane. The angle of top 108 is downward facing meaning that the front 102 is shorter than the back 106 such that the area of the top 108 connecting to the front 102 is lower than the area of the top 108 connecting to the back 106. In an embodiment, the top 108 is positioned at a downward facing angle of at least 2 degrees relative to a horizontal plane. In another embodiment, the top 108 is positioned at a downward facing angle of up to 40 degrees relative to a horizontal plane. In yet another embodiment, the top 108 is positioned at a downward facing angle ranging from 3 to 30 degrees relative to a horizontal plane. In a further embodiment, the top 108 is positioned at a downward facing angle ranging from 5 to 20 degrees relative to a horizontal plane.

The dispensing aid 100 may accommodate a container of up to 1000 fluid ounces, optionally a container of up to 500 fluid ounces, and optionally a container of up to 300 fluid ounces. In an embodiment, the container can be a liquid detergent bottle similar to the one depicted in U.S. Pat. No. 6,523,724 B2 to Paulovich, et al., which is incorporated by reference herein in its entirety.

Any textured surface (not shown) may be including on the outer surface of top 108. The texture surface may include any surface capable of increasing friction between the container and the outer surface of the top 108. The texture surface may include one or more of raised bumps or ridges, rubber or elastomeric patches or coating, or other textured surface covering at least portion of the top 108. In an embodiment, the textured surface may also include one or more of suction cups, Velcro, or any other adhesives.

The dispensing aid 100 may be of a hollow or solid construction. The dispensing aid may be of a one-piece construction or of a plurality of combined component parts. In non-limiting examples the dispensing aid may be constructed of any wood or other composite of cellulose fibers, any plastic or polymeric material, any rubber or elastomeric material, or any metallic or metal-containing material. In an embodiment, the dispensing aid may be constructed of any desired polymers and/or copolymers. In another embodiment, the dispensing aid may be constructed from one or more of polyethylene, polypropylene, polystyrene, polyvinyl chloride, polytetrafluoroethylene, and the like.

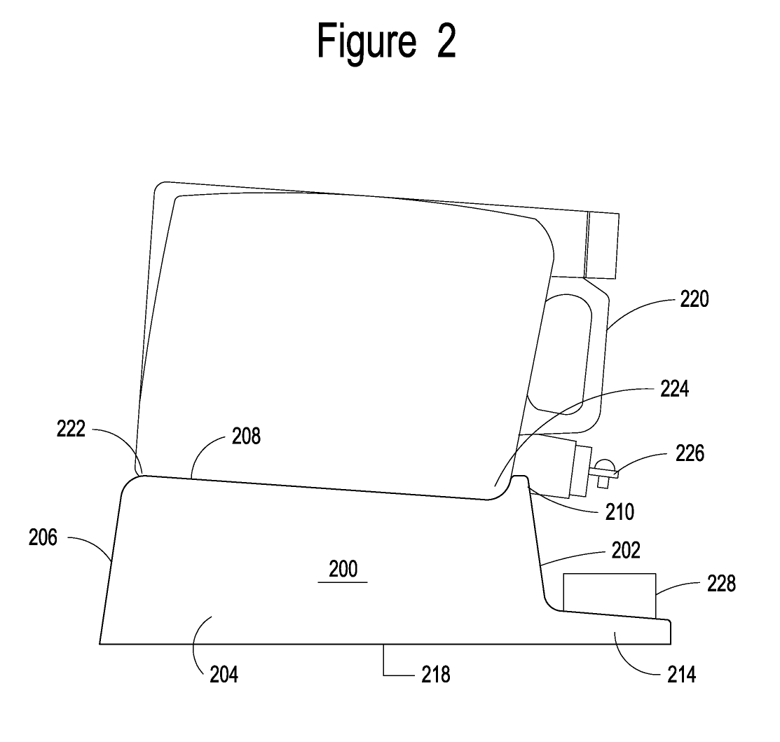

FIG. 2 depicts a dispensing aid embodiment of the present invention. In FIG. 2, the dispensing aid 200 is shown as supporting a large volume detergent bottle 220. The dispensing aid is shown from a side view having a back 206, a front 202, a bottom 218, a top 208 and a side 204. A lip 210 is shown positioned above the front 202. A cup holder 214 is shown projecting outwardly from the bottom of the front 202.

As shown in FIG. 2, the dispensing aid 200 is supporting a detergent bottle 220 at an angle. FIG. 2 depicts top 208 in a downward facing angle and as seen from FIG. 2 the front 202 is shorter than the back 206 such that the area of the top 208 connecting to the front 202 is lower than the area of the top 208 connecting to the back 206. The bottom 222 of the detergent bottle 220 is shown resting on the top 208 of the dispensing aid 200. The lip 210 acts to prevent the detergent bottle 220 from sliding off due to the downward facing angle of the dispensing aid 200.

The detergent bottle 220 is shown having a dispensing nozzle 226. The dispensing nozzle 226 is shown on the dispensing aid 200 as being positioned at the lowermost point 224 of the detergent bottle 220. The angle of top 208 of the dispensing aid 200 places the dispensing nozzle 226 of the detergent bottle 220 at or near the lowermost point 224 with respect to the entire detergent bottle 220. The cup holder 214 is shown attached to or integrated with the dispensing aid 200 in such a manner that the dispensing cup 228 resting on the cup holder 214 is positioned directly beneath the dispensing nozzle 226.

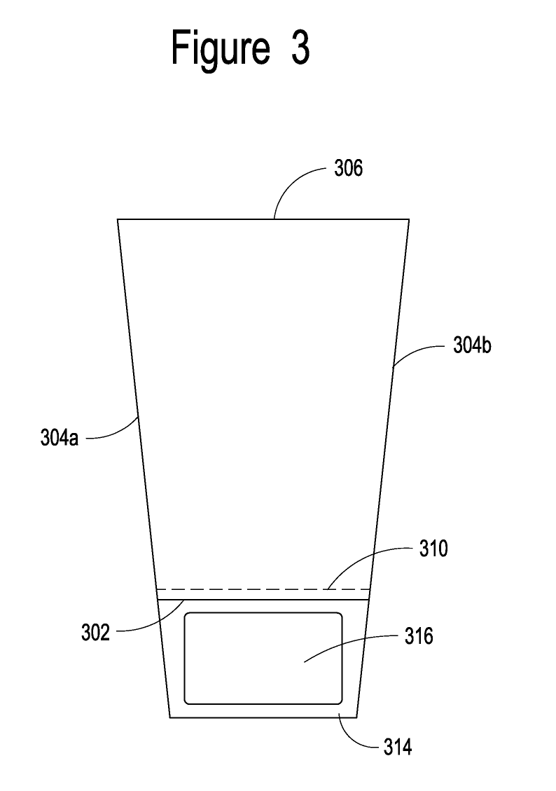

FIG. 3 is a top view of a dispensing aid 300. The dispensing aid 300 is depicted as having a back 306 and a front 302, which are connected by sides 304a,b. The back 306 may be wider than the front 302, as depicted. In an embodiment not depicted, the front 302 may be wider than the back 306. In another embodiment not depicted, the back 306 and the front 302 may each have approximately the same width. A top view of lip 310 is shown positioned above the front 302. A cup holder 314 is positioned directly in front of the front 302. The cup holder 314, as shown, contains a tray 316 positioned on top of the cup holder 314. The tray 316 may be removed from the cup holder 314 for cleaning or washing.

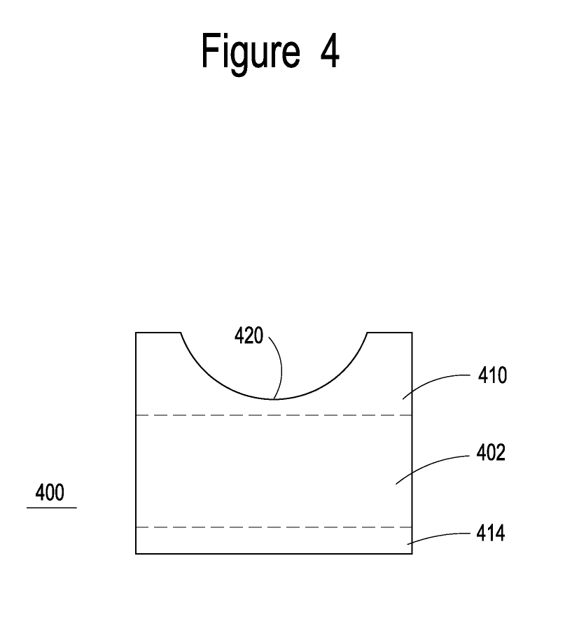

FIG. 4 is a front facing view of an embodiment of the dispensing aid 400. The dispensing aid is depicted having a front 402, a cup holder 414, and a lip 410. The cup holder 414 projects perpendicularly from the bottom of the front 402. The lip 410 projects upwardly from the top of front 402. The lip may contain a recess 420 as depicted in FIG. 4. The recess 420 may have any desired shape. In an embodiment, the recess 420 has a shape that allows a dispenser to rest over the lip 410. In another embodiment, the recess 420 is contoured to the shape of a dispenser in order to allow a dispenser to rest over the lip 410. Specifically, as depicted in FIG. 4, the recess 420 has the shape of a semicircle. In a further embodiment, the recess 420 may form the shape of a rectangle, a square, or a triangle.

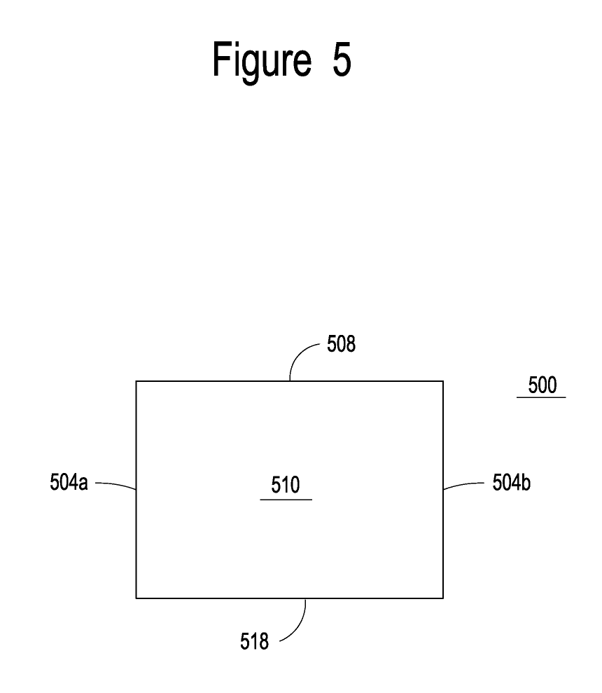

FIG. 5 is a cross-sectional view of an embodiment of the dispensing aid 500. The dispensing aid 500 is depicted as having a bottom 518, a top 508, and sides 504a,b. In an embodiment, the dispensing aid is a solid construction. In another embodiment, the dispensing aid 500 is hollow in the area 510 between the top 508 and the bottoms 518 and the sides 504a,b. In an embodiment, at least a portion of the area 510 is hollow space. In another embodiment, all of the area 510 is hollow space. The sides 504a,b are depicted as being perpendicular to the top 508 and bottom 518, resulting in a square or rectangular shaped cross-section.

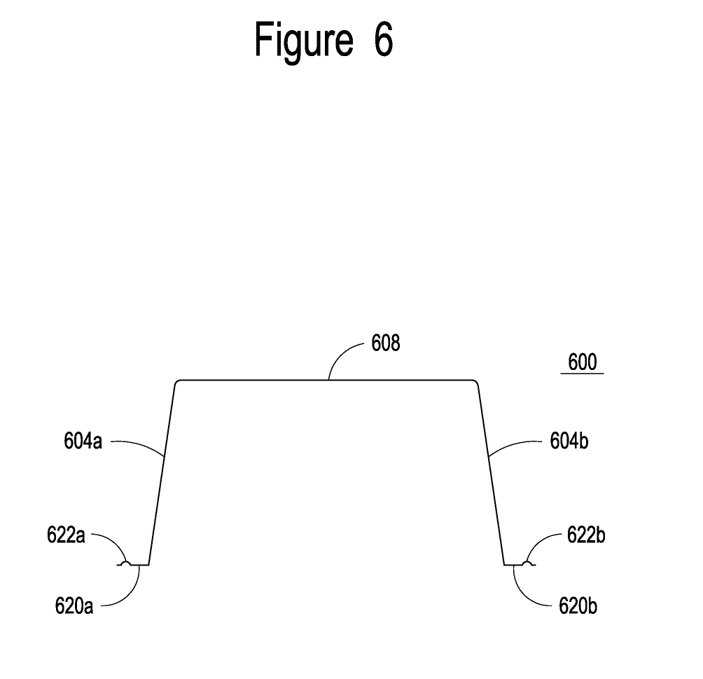

FIG. 6 is a cross-sectional view of an embodiment of the dispensing aid 600. The dispensing aid 600 is depicted as having a top 608 and sides 604a,b. The sides are depicted as containing optional base members 620a,b. The base members 620a,b may be present to provide added support for the dispensing aid 600. The sides 604a,b are depicted in FIG. 6 as having an obtuse angle with respect to the top 608, such that the base of the dispensing aid 600 is wider that the top 608. Such a wide, open base may be useful in stacking multiple dispensing aids on top of each other. The dispensing aid 600 may contain optional grooves 622a,b on the optional base members 620a,b, respectively. These optional grooves 622a,b may be used to fit over the wires of wire shelving, creating a secure resting position for the dispensing aid 600 that can prevent the dispensing aid 600 from unwanted sliding on the wire shelving.

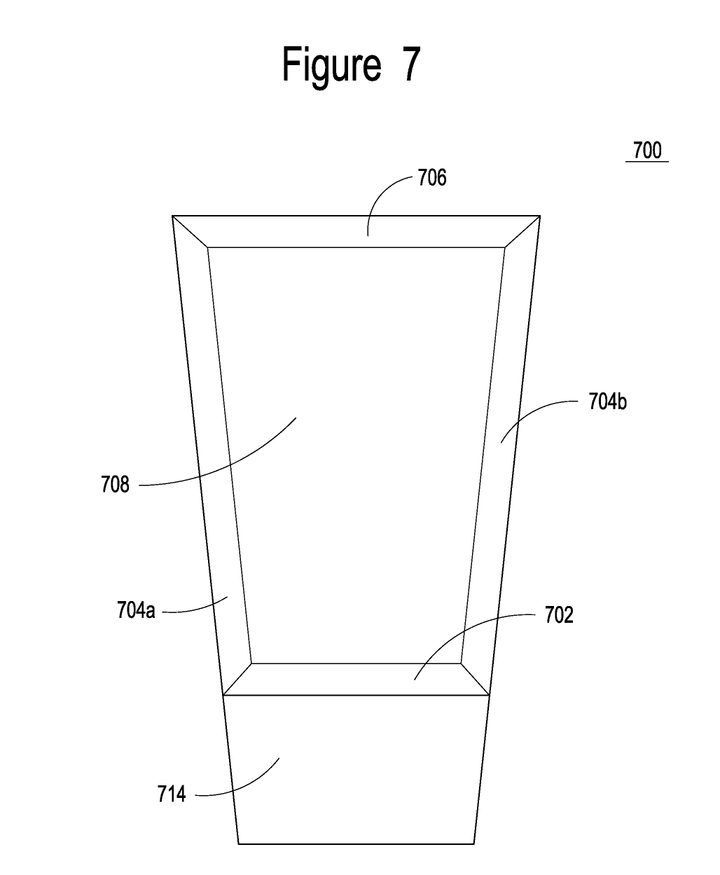

FIG. 7 is an underside view of an embodiment of the dispensing aid 700. The embodiment of the dispensing aid 700 is of a similar embodiment to the dispensing aid 600, depicted in FIG. 6, having a wide, open base. The underside of top 708, front 702, back 706, and sides 704a,b are shown in the depiction of the underside of the dispensing aid 700. As can be seen from FIG. 7, the bottom of top 708 is smaller than the opening at the base of the bottom of the dispensing aid. The underside of the cup holder 714 is seen as being attached to, or integrated with, the front 702.

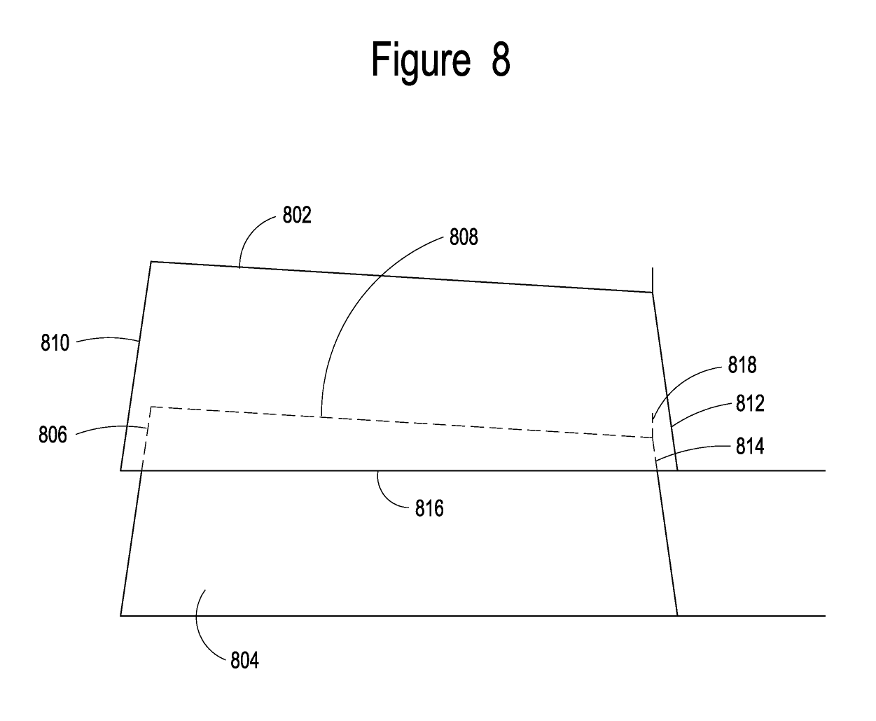

FIG. 8 is a transparent side view of two dispensing aids in a stacked arrangement. The dispensing aids depicted in FIG. 8 may include the dispensing aid embodiments as described in FIGS. 6 and 7. In an embodiment, the dispensing aids 802 and 804 each have a wide, open base that is useful in the stacking of multiple dispensing aids on top of each other. A stacking arrangement shown in FIG. 8 depicts the top dispensing aid 802 resting over the lower dispensing aid 804, such that at least a portion of the back 806 and the front 814 of the lower dispensing aid are resting within the open base 816 of the top dispensing aid 802. In the stacking arrangement of FIG. 8, the back 810 of the top dispensing aid 802 fits over the back 806 of the lower dispensing aid 804, while the front 812 of the top dispensing aid 802 fits over the lip 818 and the front 814 of the lower dispensing aid 804. In an embodiment, at least a portion of the top of the dispensing aid 804 may rest inside at least a portion of the bottom of the dispensing aid 802, wherein dispensing aids 802 and 804 have the same size and shape.

A plurality of dispensing aids may be stacked on top of each other. In an embodiment, at least two dispensing aids may be stacked on top of each other. In another embodiment, up to 100 dispensing aids may be stacked on top of each other. The dispensing aids may be stacked for eliminating storage space, aisle space in a store or for packaging purposes.

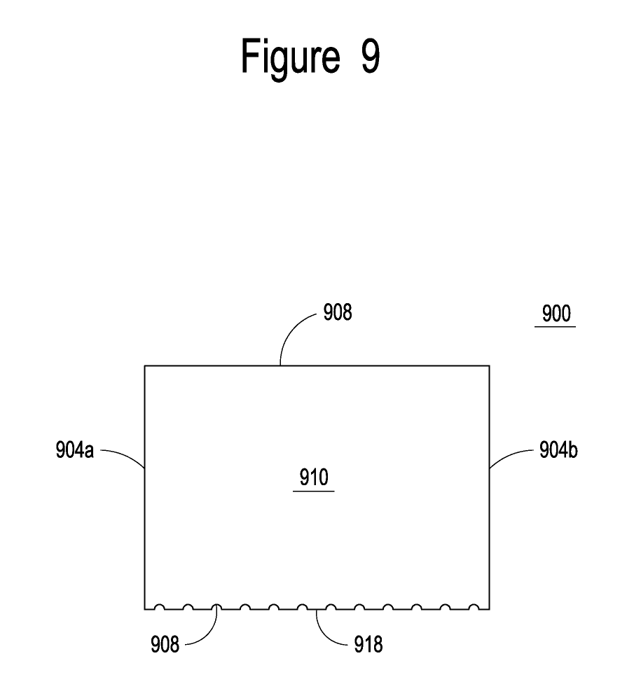

FIG. 9 is a cross-sectional view of an embodiment of the dispensing aid 900. The dispensing aid 900 is depicted as having a bottom 918, a top 908, and sides 904a,b. The bottom 918 contains a plurality of grooves 920. The grooves 920 may be used to fit over the wires of wire shelving, creating a secure resting position for the dispensing aid 900 that can prevent the dispensing aid 900 from unwanted sliding on the wire shelving. In an embodiment, a portion of the bottom 918 contains a plurality of grooves 920. In an embodiment, the portion of the bottom 918 containing a plurality of grooves 920 is the lower edge of the front (102 in FIG. 1) or the lower edge of the bach (106 in FIG. 1) to enable one dispensing aid 900 to nest within another dispensing aid 900. In an embodiment, the dispensing aid is a solid construction. In another embodiment, the dispensing aid 900 is hollow in the area 910 between the top 908 and the bottom 918 and the sides 904a,b. In an embodiment, at least a portion of the area 910 is hollow space. In another embodiment, all of the area 910 is hollow space.

Other possible embodiments include two or more of the above aspects of the invention. In an embodiment the method includes all of the above aspects and the various procedures can be carried out in any order.

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Use of the term “optionally” with respect to any element is intended to mean that the subject element is required, or alternatively, is not required. Both alternatives are intended to be within the scope. Use of broader terms such as comprises, includes, having, etc. should be understood to provide support for narrower terms such as consisting of, consisting essentially of, comprised substantially of, etc.

It is to be understood that while illustrative embodiments have been depicted and described, modifications thereof can be made by one skilled in the art without departing from the spirit and scope of the disclosure. Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Also, it is within the scope of this disclosure that the aspects and embodiments disclosed herein are usable and combinable with every other embodiment and/or aspect disclosed herein, and consequently, this disclosure is enabling for any and all combinations of the embodiments and/or aspects disclosed herein. Other and further embodiments, versions and examples of the invention may be devised without departing from the basic scope thereof and the scope thereof is determined by the claims that follow.

What is claimed is:

1. A liquid detergent dispensing aid apparatus, comprising:
a structure having four sides and a top, wherein the four sides comprise a front segment and a back segment connected by two sides; and
a cup holder means attached to a bottom portion of the front segment;
wherein the front segment has a height shorter than the back segment; and
wherein the top has a downward angle relative to a horizontal plane facing the front segment.

2. The apparatus of claim 1, further comprising a lip positioned above the front segment.

3. The apparatus of claim 2, wherein the lip is adapted to receive a dispensing nozzle of a detergent bottle.

4. The apparatus of claim 1, wherein the top comprises an outer surface wherein at least a portion of the outer surface comprises a textured surface.

5. The apparatus of claim 1, wherein the cup holder means comprises a removable tray.

6. The apparatus of claim 1, wherein the downward facing angle is at least 2 degrees relative to the horizontal plane.

7. The apparatus of claim 1, wherein the downward facing angle ranges from 3 to 30 degrees relative to the horizontal plane.

8. The apparatus of claim 1, wherein the structure comprises a base that is wider than the top.

9. The apparatus of claim 8, wherein the structure comprises a shape that allows for multiple dispensing aids having the same size and shape to be stacked on top of each other, wherein at least a portion of the top of a dispensing aid can fit within the bottom of another dispensing aid.

10. The apparatus of claim 4, wherein the textured surface comprises one or more of raised bumps, raised ridges, rubber patches, elastomeric patches, suction cups, Velcro, or adhesives.

11. A liquid detergent dispensing system, comprising:
a structure having four sides, a bottom, and a top, wherein the four sides comprise a front segment and a back segment connected by two sides;
a liquid detergent bottle resting on the top;
a cup holder attached to a bottom portion of the front segment; and
a cup resting on the cup holder;
wherein the front segment has a height shorter than the back segment;
wherein the top has a downward angle relative to a horizontal plane facing the front segment; and
wherein the liquid detergent bottle comprises a dispensing nozzle that is positioned over the cup resting on the cup holder.

12. The liquid detergent dispensing system of claim 11, further comprising a lip positioned above the front segment, wherein the lip is adapted to receive the dispensing nozzle.

13. The liquid detergent dispensing system of claim 12, wherein the lip comprises a recess having a semicircular shape.

14. The liquid detergent dispensing system of claim 11, wherein at least a portion of the bottom of the structure comprises a plurality of grooves.
